(19) United States
(12) Patent Application Publication
(10) Pub. No.: US 2026/0039547 A1
(43) Pub. Date: Feb. 5, 2026

(54) CORRECTION DEVICE, COMMUNICATION SYSTEM, AND CORRECTION METHOD

(71) Applicant: DENSO CORPORATION, Kariya-city (JP)

(72) Inventors: Takuto YOSHIDA, Kariya-city (JP); Yasuhiro KOTANI, Kariya-city (JP)

(21) Appl. No.: 19/252,572

(22) Filed: Jun. 27, 2025

(30) Foreign Application Priority Data
Aug. 2, 2024 (JP) 2024-127706

(51) Int. Cl. H04L 41/0816; H04L 41/0604

(52) U.S. Cl. CPC H04L 41/0816; H04L 41/0627

(57) ABSTRACT

A correction device included in a communication system is configured to determine whether a communication parameter, which is set in a transmission setting for transmitting a frame in at least one target device, needs to be corrected based on time information included in a frame. The correction device is configured to adjust the communication parameter to suppress a deterioration in a communication quality in response to determining that the communication parameter needs to be corrected. Then, the correction devices is configured to notify the at least one target device of a new communication parameter that has been adjusted.

### CROSS REFERENCE TO RELATED APPLICATION

The present application claims the benefit of priority from Japanese Patent Application No. 2024-127706 filed on Aug. 2, 2024. The entire disclosure of the above application is incorporated herein by reference.

### TECHNICAL FIELD

The present disclosure relates to a correction device, a communication system, and a correction method.

### BACKGROUND

There has been known a technology for correcting a transmission time at which a communication device transmits data in a communication network.

### SUMMARY

According to an aspect of the present disclosure, a correction device used in a communication system is provided. The communication system includes multiple communication devices and at least one relay device via which the multiple communication devices are communicatively connected. The multiple communication devices include a first communication device and a second communication device. The correction device is one of the multiple communication devices. The correction device includes at least one of (i) a circuit and (ii) a processor with a memory storing computer program code executable by the processor, and the at least one of the circuit and the processor is configured to cause the correction device to implement a determination unit ant a correction notification unit. The determination unit may be configured to determine whether a communication parameter, which is set in a transmission setting for transmitting a frame in at least one target device, needs to be corrected based on time information, which is included in the frame when the frame is transmitted from the first communication device to the second communication device via the at least one relay device. The at least one target device is defined as the first communication device and/or the at least one relay device, and the at least one target device performs a communication according to the communication parameter, which is related to a communication quality. The correction notification unit may be configured to adjust the communication parameter to suppress a deterioration in the communication quality when the determination unit determines that the communication parameter needs to be corrected. The correction notification unit is further configured to notify the at least one target device of a new communication parameter that has been adjusted. The at least one target device corrects the communication parameter in response to the new communication parameter being notified by the correction notification unit of the correction device.

### BRIEF DESCRIPTION OF DRAWINGS

Features of the present disclosure will become apparent from the following detailed description made with reference to the accompanying drawings. In the drawings:

FIG. 1 is a schematic diagram showing a configuration example of a communication system;

FIG. 2 is a block diagram showing a configuration of the communication system;

FIG. 3 is a flowchart showing a correction notification process;

FIG. 4A is an example of a graph in a case where an amount of communication data is biased per unit time;

FIG. 4B is an example of a graph in a case where an amount of communication data is less biased per unit time;

FIG. 5A is a diagram for explaining an example of transmission time points of data A, B, and C;

FIG. 5B is a diagram for explaining an example of receiving time points of data A, B, and C;

FIG. 6 is a diagram showing an example of a schematic configuration of a communication system according to a first modification example;

FIG. 7 is a diagram showing an example of a schematic configuration of a communication system according to a second modification example; and

FIG. 8 is a block diagram showing a configuration of a communication system according to a third modification example.

### DETAILED DESCRIPTION

In a related art, when a difference between a reception time at which a relay device actually receives data from the communication device and a pre-scheduled transmission time at which the communication device transmitted the data is equal to or larger than a predetermined threshold, the relay device transmits a correction request to the communication device to correct the transmission time at which the communication device plans to transmit the data.

After performing a detailed study to the known correction technology of transmission time by the inventors of the present disclosure, it is found that the technology disclosed in the related art only corrects the transmission time at which the communication device transmits the data, and does not take into consideration optimizing a communication quality of the entire communication network by correction of the transmission time.

According to an aspect of the present disclosure, a correction device used in a communication system is provided. The communication system includes multiple communication devices and at least one relay device via which the multiple communication devices are communicatively connected. The multiple communication devices include a first communication device and a second communication device. The correction device is one of the multiple communication devices. The correction device includes at least one of (i) a circuit and (ii) a processor with a memory storing computer program code executable by the processor, and the at least one of the circuit and the processor is configured to cause the correction device to implement a determination unit ant a correction notification unit. The determination unit is configured to determine whether a communication parameter, which is set in a transmission setting for transmitting a frame in at least one target device, needs to be corrected based on time information, which is included in the frame when the frame is transmitted from the first communication device to the second communication device via the at least one relay device. The at least one target device is defined as the first communication device and/or the at least one relay device, and the at least one target device performs a communication according to the communication parameter, which is related to a communication quality. The correction notification unit is configured to adjust the communication parameter to suppress a deterioration in the communication quality when the determination unit determines that the communication parameter needs to be corrected. The correction notification unit is further configured to notify the at least one target device of a new communication parameter that has been adjusted. The at least one target device corrects the communication parameter in response to the new communication parameter being notified by the correction notification unit of the correction device.

According to the above configuration, at least time information included in the frame, which is transmitted from the first communication device and is received by the second communication device via at least one relay device, is collected in the correction device. Then, the correction device can use the collected information to adjust communication parameter to optimize the communication quality of entire communication network. Furthermore, the at least one target device corrects the communication parameter when the new communication parameter is notified by the correction device. As a result, the communication parameter can be reset to the new communication parameter. Thus, the correction device can automatically optimize the communication network by correcting the communication parameter. The correction device is therefore able to optimize the communication quality of communication network.

The present disclosure can also be implemented as a communication system including the above-described correction device and a correction method executed by the above-described correction device.

The following will describe exemplary embodiments of the present disclosure with reference to the drawings.

### 1. First Embodiment

### 1-1. Configuration

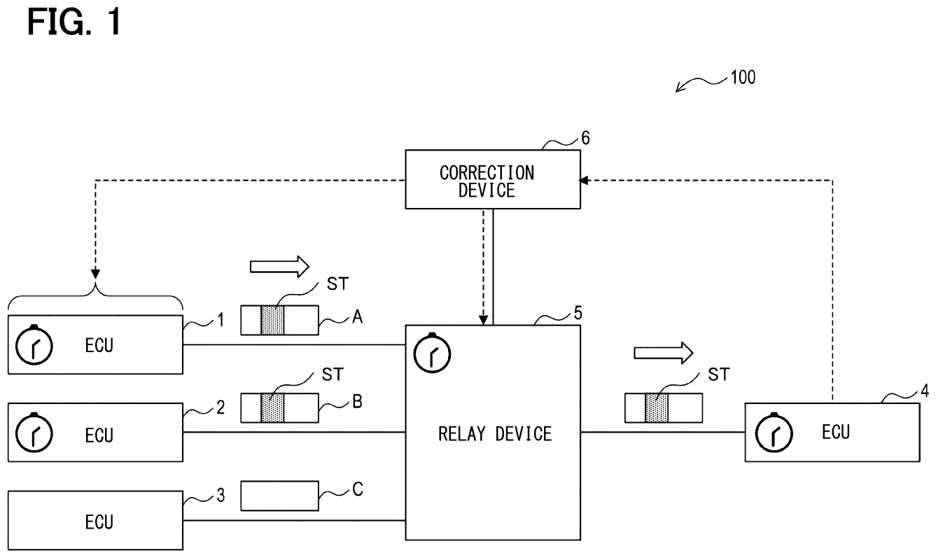

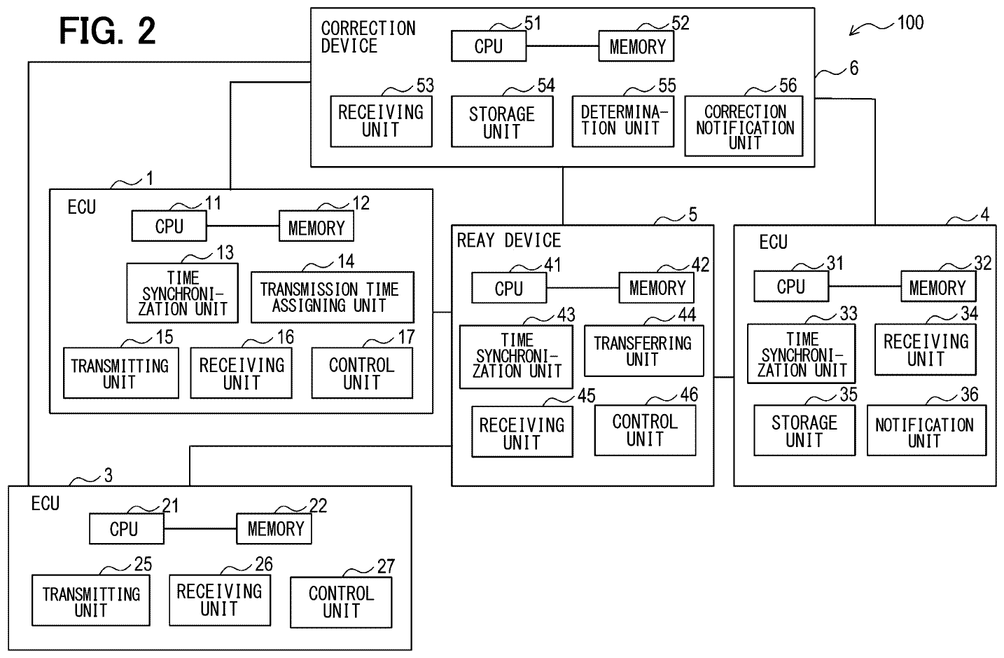

As shown in FIG. 1 and FIG. 2, a communication system 100 according to the present embodiment configures an Ethernet (registered trademark) network system mounted on a vehicle, such as a passenger vehicle. The communication system 100 is capable of performing network communication using a function provided by Ethernet TSN. The network system configured by the communication system 100 is not limited to Ethernet, and any network using a different communication protocol may be used as the network system. An optional communication protocol may be LIN, CAN, FlexRay, MOST, or CXPI. TSN stands for Time-Sensitive Networking. LIN is an abbreviation for Local Interconnect Network. CAN is an abbreviation for Controller Area Network. MOST is an abbreviation for Media Oriented Systems Transport. CXPI is an abbreviation for Clock Extension Peripheral Interface.

The communication system 100 includes multiple electronic control units (ECU), that is, ECU 1, ECU 2, ECU 3, and ECU 4 (hereinafter referred to as ECU 1 to ECU 4), a relay device 5, and a correction device 6. These components are connected with one another by communication lines. Specifically, each of the ECUs 1 to 4 is connected to the relay device 5 via a communication line. The correction device 6 is connected to the ECU 1 to ECU 4 and the relay device 5 via communication lines. ECU is an abbreviation for Electronic Control Unit. Although the ECU 2 is omitted in FIG. 2, the ECU 2 has a similar configuration to the ECU 1, and the description of the ECU 1 described later also applies to the ECU 2.

The ECU 1 to ECU 4 each is connected to sensors, actuators, or the like (not shown). For example, each of the ECU 1 to ECU 4 transmits data (for example, frames) obtained from a sensor to another ECU via the relay device 5. For example, each of the ECU 1 to ECU 4 operates an actuator based on data received from another ECU via the relay device 5. For example, each of the ECU 1 to ECU 4 has a function of transmitting and receiving data to and from the relay device 5 connected thereto.

In the communication system 100, the ECU 1 to ECU 4 are connected to one another so as to be able to communicate with one another via the relay device 5. The ECU 1 to ECU 4 are configured to be able to transmit and receive data to and from one another via the relay device 5. The present embodiment will be described under a situation in which the ECU 1 to ECU 3 function as transmitters that transmit data, and the ECU 4 functions as a receiver that receives data. For example, in the configuration shown in FIG. 1, the ECU 1 transmits data A, the ECU2 transmits data B, and the ECU3 transmits data C. The ECU 1 to ECU 3 may be referred to as transmitting devices, and the ECU 4 may be referred to as a receiving device. The ECU 1 to ECU 4, the relay device 5, and the correction device 6 may also be referred to as nodes.

### 1-1-1. Transmitting Device

As shown in FIG. 2, the ECU 1 includes a CPU 11 and a memory 12. The memory 12 stores programs to be executed by the CPU 11 to perform predetermined functions. The memory 12 also stores a first transmission setting, which is a setting for transmitting frames. The first transmission setting includes parameters such as a frame transmission cycle, a frame transmission time offset, a frame priority, an Ethernet TSN setting, a frame format, MAC address of transmission source, and MAC address of transmission destination.

The frame transmission time offset is a setting value for setting a transmission time of frame to be different from a reference transmission time of frame. For example, when multiple nodes have the same transmission cycle, by setting the offset different from one another, the transmission time of frames can be shifted from one another.

As an example of the frame priority, a PCP value of VLAN tag defined in IEEE 802.1Q may be used. IEEE is an abbreviation for Institute of Electrical and Electronics Engineers. VLAN is an abbreviation for Virtual Local Area Network. PCP is an abbreviation for Priority Code Point.

The Ethernet TSN setting may include settings for functions defined in, IEEE802.1Qav, IEEE802.1Qcr, IEEE802.1Qbv, and the like. The Ethernet TSN setting may include setting about a time slot assigned to each node and credit parameter.

Among the first transmission setting set in the transmitting device, a parameter related to communication quality is referred to as a first communication parameter. The first communication parameter is recorded in the memory 12 in a rewritable manner.

The communication quality here is an index for evaluating a performance and a configuration of the network which is implemented by the communication system 100. The index for evaluating the network may be an index that evaluates an efficiency of transmitting and receiving frames and a utility efficiency by which the network resource is utilized efficiently. In the communication system 100, delay time, jitter, buffer capacity, processing load, and the like are used as the index.

The delay time indicates a time required for a frame to be transmitted from a transmission source to a transmission destination. When the delay time satisfies a predetermined required value in the communication system 100, the communication quality can be evaluated as good. The jitter indicates a change in delay time. When a range of change in delay time satisfies a predetermined required value in the communication system 100, the communication quality can be evaluated as good.

The buffer indicates, as an example, a storage area for storing a frame after the relay device 5 receives the frame from the transmitting device and before transferring the received frame to the receiving device. When the buffer capacity is appropriate, the communication quality can be evaluated as good. The buffer capacity being appropriate refers to a situation in which the buffer capacity is equal to or greater than a predetermined value and it is less likely to discard the frames already stored in the buffer or newly received frames due to insufficient buffer capacity. When there is no need to discard the frames already stored in the buffer or newly received frames, all frames can be transferred, and the communication quality can be evaluated as good.

The processing load indicates, as an example, a processing load of a CPU 41 of the relay device 5. Specifically, the processing load shows a processing load required when performing a switching processing using the VLAN. When the processing load satisfies a predetermined required value in the communication system 100, the communication quality can be evaluated as good.

The first communication parameters include, at least, a frame transmission cycle, a frame transmission time offset, and a frame priority out of parameters of the first transmission setting. The first communication parameters may include a setting of Ethernet TSN, or the like.

The ECU 1 implements functions of the following units when the CPU 11 executes the programs stored in the memory 12. The ECU 1 has the functions of a time synchronization unit 13, a transmission time assigning unit 14, a transmitting unit 15, a receiving unit 16, and a control unit 17.

The time synchronization unit 13 is configured to synchronize the time with another node that includes a time synchronization unit. The time synchronization may be performed according to IEEE802.1AS. Specifically, the local time used in one node is synchronized with the global time used in another node.

The transmission time assigning unit 14 is configured to assign a transmission time ST of a frame to a header of the frame. The frame header may use a format defined under IEEE 1722.

The transmitting unit 15 is configured to transmit the frames to the receiving device. The transmitting unit 15 transmits the frames in accordance with the first transmission setting. The transmitting unit 15 transmits the frames in accordance with at least the first communication parameters.

The receiving unit 16 is configured to receive new first communication parameters from the correction device 6. The receiving unit 16 is also configured to receive the frames from other ECU 2 to ECU 4 via the relay device 5.

The control unit 17 is configured to correct the first communication parameters to the new first communication parameters received by the receiving unit 16. The control unit 17 is configured to correct the first communication parameters to the new first communication parameters notified by the correction device 6. The control unit 17 updates the first communication parameters recorded in the memory 12 to the new first communication parameters. As a result, the next time the transmitting unit 15 transmits a frame, the transmitting unit 15 can transmit the frame to the receiving device in accordance with the updated new first transmission setting.

The ECU 3 includes a CPU 21 and a memory 22. The memory 22 stores programs to be executed by the CPU 21 to perform predetermined functions. The memory 22 stores the first transmission setting. The memory 22 stores the first communication parameters in rewritable manner.

The ECU 3 implements functions of the following units when the CPU 21 executes the programs stored in the memory 22. That is, the ECU 3 has the functions of a transmitting unit 25, a receiving unit 26, and a control unit 27. The ECU 3 differs from the ECU 1 in that the ECU 3 does not include a time synchronization unit and a transmission time assigning unit.

The transmitting unit 25 is configured to transmit the frames to the receiving device. The transmitting unit 25 transmits the frames in accordance with the first transmission setting. Since the ECU 3 does not include the time synchronization unit 13 and the transmission time assigning unit 14, the header of frame transmitted from the ECU 3 does not include the transmission time ST of the frame.

The receiving unit 26 and the control unit 27 have the same configuration as the receiving unit 16 and the control unit 17 of the ECU 1. The receiving unit 26 is also configured to receive the frames from other ECU 1, ECU 2, and ECU 4, via the relay device 5.

### 1-1-2. Receiving Device

The ECU 4 includes a CPU 31 and a memory 32. The memory 32 stores programs to be executed by the CPU 31 for performing predetermined functions.

The ECU 4 implements functions of the following units when the CPU 31 executes the programs stored in the memory 32. That is, the ECU 4 has the functions of a time synchronization unit 33, a receiving unit 34, a storage unit 35, and a notification unit 36.

The time synchronization unit 33 is configured to synchronize the time with another node that includes a time synchronization unit.

The receiving unit 34 is configured to receive a frame transmitted from the transmitting device via the relay device 5.

The storage unit 35 is configured to store notification information. The notification information is information related to the frame transmitted by the transmitting device. The notification information may include traffic information from when a frame is transmitted by the transmitting device to when the frame is received by the receiving device. The notification information includes at least time information. The notification information includes a transmission time ST, which is the time when the transmitting device transmits the frame, a reception time, which is the time when the receiving device receives the frame, a size of the frame, a priority of the frame, a transmission source address, or the like.

The notification unit 36 is configured to notify the correction device 6 of the notification information stored in the storage unit 35. The notification unit 36 is configured to periodically collectively notify the correction device 6 of the notification information stored in the storage unit 35. The notification unit 36 may notify the correction device 6 of the notification information each time a frame transmitted from one of the ECU 1 to 3 is received.

### 1-1-3. Relay Device

The relay device 5 has a relay function of transferring a frame received from an ECU, which is connected to the relay device 5, to another ECU, which is connected to the relay device 5. In the present embodiment, the relay device 5 relays communications among the ECU 1 to ECU 4. The relay device 5 may also have a function of gateway device. By having the function of gateway device, the relay device 5 can relay frames (data) between different communication protocols. The relay device 5 further has a function of relaying frames between different VLANs.

The relay device 5 is implemented by a microcomputer including a CPU 41 and a memory 42. The memory 42 stores programs to be executed by the CPU 41 to perform predetermined functions. The memory 42 also stores a second transmission setting, which is a setting for transmitting or relaying the frames. The second transmission setting includes parameters, such as a forwarding table, an access control list, and Ethernet TSN setting. Among the second transmission setting, the parameters related to the communication quality is referred to as second communication parameters. The second communication parameters are stored in the memory 42 in rewritable manner.

The forwarding table is a data table that indicates forwarding paths. Specifically, the forwarding table is a data table that associates a MAC address of frame transmission source with a MAC address of forwarding destination.

The access control list may be a list in which conditions of frames to be transferred through the relay device 5 are set. The frames that satisfy the conditions set in the access control list are allowed to be forwarded, and frames that do not meet the conditions are discarded.

The Ethernet TSN setting may include settings for functions defined in, IEEE802.1Qav, IEEE802.1Qcr, IEEE802.1Qbv, and the like. More specifically, the Ethernet TSN settings include settings for output policing, or the like.

The second communication parameters include at least the Ethernet TSN setting among the parameters of the second transmission setting. The second communication parameters may include a forwarding table, an access control list, and the like.

The relay device 5 implements functions of the following units when the CPU 41 executes the programs stored in the memory 42. That is, the relay device 5 has the functions of a time synchronization unit 43, a transferring unit 44, a receiving unit 45, and a control unit 46.

The time synchronization unit 43 is configured to synchronize the time with another node that has a time synchronization unit.

The transferring unit 44 is configured to transfer the frame transmitted from the transmitting device to the receiving device. The transferring unit 44 also determines whether a transmission time ST is added to the header of frame, which is transmitted from the transmitting device. When the transferring unit 44 determines that the transmission time ST is not added to the header of frame, the transferring unit 44 is configured to add the relay reception time, which is the time when the relay device 5 receives the frame, to the header of frame as the transmission time ST.

The receiving unit 45 is configured to receive new second communication parameters from the correction device 6.

The control unit 46 is configured to correct the second communication parameters to new second communication parameters received by the receiving unit 45. The control unit 46 is configured to correct the second communication parameters to the new second communication parameters notified by the correction device 6. The control unit 46 updates the second communication parameters recorded in the memory 42 to the new second communication parameters. As a result, the next time the transferring unit 44 transfers a frame, the transferring unit 44 can transfer the frame to the receiving device in accordance with the new second transmission setting.

### 1-1-4. Correction Device

The correction device 6 is a communication device for correcting the first communication parameters and the second communication parameters to optimize the communication quality of the communication network configured by the communication system 100.

The correction device 6 includes a CPU 51 and a memory 52. The memory 52 stores programs to be executed by the CPU 51 to perform predetermined functions. The memory 52 stores the first communication parameters of each transmitting device and the second communication parameters of the relay device 5 in a rewritable manner.

The correction device 6 implements functions of the following units when the CPU 51 executes the programs stored in the memory 52. The correction device 6 has the functions of a receiving unit 53, a storage unit 54, a determination unit 55, and a correction notification unit 56.

The receiving unit 53 is configured to receive the notification information notified by the notifying unit 36 of the receiving device.

The storage unit 54 is a storage device for storing the notification information received by the receiving unit 53.

The determination unit 55 is configured to determine whether the first communication parameters and the second communication parameters need to be corrected based on at least time information included in the notification information stored in the storage unit 54.

The correction notification unit 56 is configured to adjust the first communication parameters and the second communication parameters so as to suppress deterioration of communication quality when the determination unit 55 determines that correction of the first communication parameters and the second communication parameters is necessary. The correction notification unit 56 is configured to notify the transmitting device and the relay device 5 of the new first and second communication parameters which have been adjusted. The first and second communication parameters stored in the memory 52 are also updated to the new adjusted first and second communication parameters. The correction notification process performed by the determination unit 55 and the correction notification unit 56 will be described in detail later.

Each of the ECU 1 to ECU 4, the relay device 5, and the correction device may be implemented by one microcomputer or multiple microcomputers.

The method of performing the function of each unit included in the ECU 1 to ECU 4, the relay device 5, and the correction device 6 is not limited in software manner. Partial or all of the functions may be implemented using one or more hardware circuits in hardware manner. For example, when the above-described functions are implemented by an electronic circuit, which is a hardware circuit, the electronic circuit may be implemented by a digital circuit, an analog circuit, or a combination of digital circuit and analog circuit.

### 1-2. Process

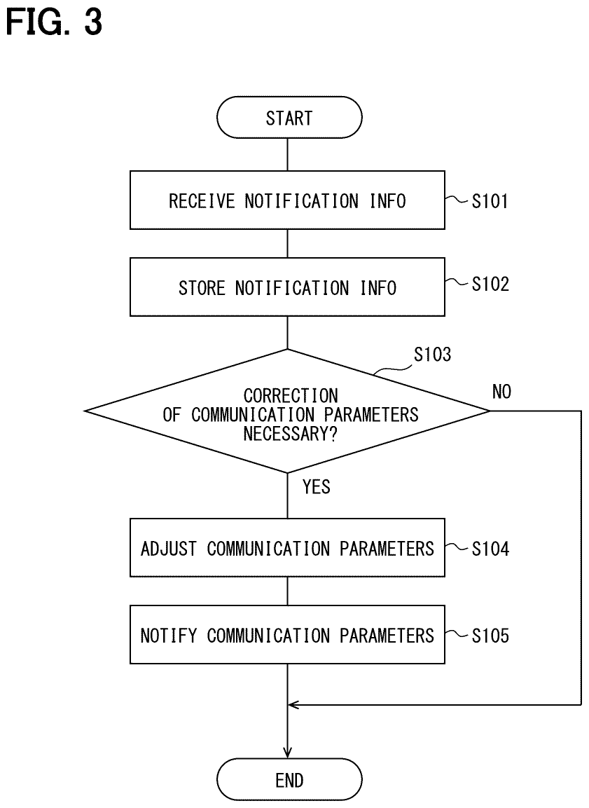

The correction notification process executed by the correction device 6 will be described with reference to the flowchart shown in FIG. 3. The correction notification process is repeatedly executed while the ignition switch is in turn-on state. Hereinafter, the first communication parameter and/or the second communication parameters may be referred to as notification parameters.

In S101, the receiving unit 53 of the correction device 6 receives the notification information from the ECU 4.

In S102, the correction device 6 stores the notification information received from the ECU 4 in the storage unit 54.

In S103, the determination unit 55 of the correction device 6 determines whether the notification parameters need to be corrected based on the notification information. In the present embodiment, the determination unit 55 determines whether a difference between the transmission time ST, which is the time when each of the ECU 1 to ECU transmitted a frame, and a reception time, which is the time when the ECU 4 received the frame, is equal to or greater than a predetermined tolerance value. That is, the determination unit 55 calculates the delay time from the difference between the transmission time ST and the reception time of each frame, and determines whether the delay time is equal to or greater than the tolerance value. When the determination unit 55 determines that the difference between the transmission time ST and the reception time is equal to or greater than the tolerance value, the determination unit determines that the communication parameters need to be corrected.

When the correction device 6 determines in S103 that the communication parameters need to be corrected, the process proceeds to S104. When the correction device 6 determines in S103 that the communication parameters do not require correction, the current correction notification process is ended.

In S104, the correction notification unit 56 of the correction device 6 adjusts the communication parameters so as to suppress the deterioration of communication quality. In the present embodiment, the correction notification unit 56 adjusts the communication parameters so that the difference between the transmission time ST and the reception time falls below the tolerance value. That is, the correction notification unit 56 adjusts the communication parameters so that the delay time falls below the tolerance value. In the adjustment of the communication parameters, the correction notification unit 56 may change the settings about the transmission cycle, offset, and priority in the ECU 1 to ECU 3, and changes the settings such as output policing in the relay device 5.

As an example, consider a case where the difference between the transmission time ST and the reception time in the ECU 1 is equal to or greater than the tolerance value. When the frames from ECU 1 to 3 are accumulated in the buffer of the relay device 5 and the priority of the frame from ECU 1 is lower than the priorities of the frames from the ECU 2 and the ECU 3, there is a possibility that the frames from the ECU 2 and the ECU 3, which have higher priorities, are relayed first. Therefore, it is possible that the frame from the ECU 1 is stored in the buffer of the relay device 5 for a long time. Therefore, the correction notification unit 56 may adjust the priority of the frame from the ECU1 to be higher than the priorities of the frames of the ECU2 and the ECU3. For example, the correction notification unit 56 may change the output policing in the relay device 5 so that the frame from the ECU 1 is transferred with higher priority by the relay device 5.

For example, suppose that the transmission time of ECU1 conflicts with the transmission time of the ECU2 and the transmission time of the ECU3, and it takes a long time for the relay device 5 to transfer the frames to the receiving devices. In this case, if the transmission cycles of ECU1 to ECU3 are the same, the offset of ECU1 may be adjusted to be different from the offsets of ECU2 and ECU3 so that the transmission time of ECU1 does not conflict with the transmission time of ECU2 and the transmission time of ECU3. For example, the correction notification unit 56 may adjust the transmission cycles of the ECU 1 to ECU 3 so as to be different from one another.

In S105, the correction notification unit 56 notifies the ECU 1 to ECU 3 and the relay device 5 of the new communication parameters that have been adjusted. For example, in the above-described case, the correction notification unit 56 may notify the ECU 1 of the PCP value of the new VLAN tag. For example, the correction notification unit 56 may notify the ECU 1 of new transmission cycle or new offset value. For example, the correction notification unit 56 may notify the relay device 5 of new setting value for output policing.

Then, the correction device 6 ends the current correction notification process.

Upon receiving the new communication parameters, the ECU 1 to ECU 3 and the relay device 5 correct the currently recorded communication parameters. Specifically, the transmitting device corrects the first communication parameters recorded in the memory 12, 22 to the new first communication parameters. The relay device 5 corrects the second communication parameters recorded in the memory 42 to the new second communication parameters.

### 1-3. Technical Effects

According to the first embodiment described above, the following effects are obtained.
(1a) In the above embodiment, when the correction notification unit 56 of the correction device 6 determines that the communication parameters need to be corrected, the correction notification unit 56 adjusts the communication parameters so as to suppress deterioration of communication quality.

The first transmission setting of the transmitting device and the second transmission setting of the relay device 5 are designed and verified so as to satisfy predetermined required values for delay time and jitter. In vehicles provided with SDVs where functions can be added or updated after the vehicle is sold, the software need to be updated frequently. It is difficult to change and verify the network configuration every time software is updated. SDV stands for Software Defined Vehicle.

According to the above-described configuration, the notification information is collected by the correction device 6. Since traffic information of the entire network is collected in the correction device 6, the correction device 6 can adjust the communication parameters to optimize the entire network. Therefore, even when the software is updated, the transmitting device can correct the first communication parameter. The relay device 5 can correct the second communication parameter. In the communication system 100, the first transmission setting and the second transmission setting can be reconfigured without physically changing the network. That is, the communication system 100 can automatically optimize the network and correct the communication parameters. Therefore, in the communication system 100, the communication quality of the communication network can be properly optimized.
(1b) In the above embodiment, when the determination unit 55 of the correction device 6 determines that the difference between the transmission time ST and the reception time is equal to or greater than the tolerance value, the determination unit determines that the communication parameters need to be corrected. The correction notification unit 56 of correction device 6 adjusts the communication parameters so that the difference between the transmission time ST and the reception time falls below the tolerance value. With this configuration, the delay time from transmission source of the frame to the transmission destination of the frame, which receives the frame, can be maintained within the tolerance value. Therefore, the communication quality of communication network can be properly optimized.

### 1-4. Correspondence

In the first embodiment, the process executed in S103 corresponds to the determination unit, and the process executed in S104 and S105 corresponds to the correction notification unit. The ECU 1 to ECU 3 each corresponds to a first communication device, and the ECU 4 corresponds to a second communication device. The first communication parameters and the second communication parameters correspond to the communication parameters.

### 2. Second Embodiment

### 2-1. Difference From First Embodiment

The fundamental configuration of the second embodiment is similar to that of the first embodiment. Therefore, the difference therebetween will be mainly described below. The same reference symbol as in the first embodiment denote the same element, and reference is made to the preceding description.

In the second embodiment, the specific process for determining whether the communication parameters need to be corrected in S103 of FIG. 3 is different from the first embodiment. The specific process for adjusting the communication parameters so as to suppress the deterioration of the communication quality is different from that executed in S104 of FIG. 3 in the first embodiment. Further, the specific values of the communication parameters to be notified are different from the specific values notified in S105 of FIG. 3 in the first embodiment.

### 2-2. Process

In S103, the determination unit 55 of the correction device 6 determines whether there is a bias in the amount of communication data per unit time using the amount of communication data per unit time. The amount of communication data per unit time is calculated based on the transmission time ST, which is the time when each of the ECU 1 to ECU 3 transmitted the frame, and the size of each frame transmitted by each of the ECU 1 to ECU 3. When the determination unit 55 determines that there is a bias in the amount of communication data per unit time, the determination unit determines that the communication parameters need to be corrected. The amount of communication data per unit time may be calculated in advance as statistical information before the present correction notification process is executed.

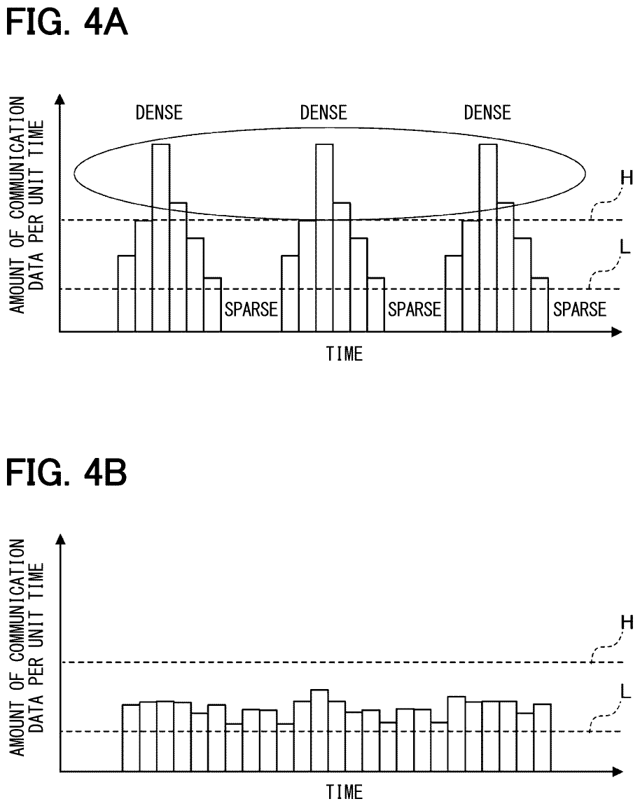

The determination unit 55 uses the amount of communication data per unit time to determine whether there are dense sections where the amount of communication data per unit time is relatively large and sparse sections where the amount of communication data per unit time is relatively small. As shown in FIG. 4A, when the determination unit 55 determines that there are dense sections and sparse sections, the determination unit determines that the communication parameters need to be corrected.

The determination unit 55 determines whether the amount of communication data exceeds an upper reference value H. When the determination unit 55 determines that the amount of communication data exceeds the upper reference value H, the determination unit determines that a dense section exists. The determination unit 55 also determines whether the amount of communication data is below a lower reference value L. When the determination unit 55 determines that the amount of communication data is below the lower reference value L, the determination unit determines that a sparse section exists. The upper reference value H and the lower reference value L are predetermined reference values for classifying the amount of communication data per unit time into large and small amounts. The upper reference value H is set to a value greater than the lower reference value L.

In S104, the correction notification unit 56 of the correction device 6 adjusts the communication parameters so as to suppress the bias in the amount of communication data per unit time. The correction notification unit 56 may adjust the communication parameters so that one of the ECU 1 to ECU 3, which has transmitted a frame to the dense section, transmits the frame to the sparse section. The correction notification unit 56 may change the settings of the transmission cycle, offset, and the like in the ECU 1 to ECU 3.

Suppose that the ECU1 and the ECU2 transmit frames in a dense section. When the transmission cycles and offsets of the frames transmitted by the ECU1 and the ECU2 are the same as one another, the correction notification unit 56 may adjust the offset in one of the ECU 1 and the ECU 2 to be changed. For example, the correction notification unit 56 may adjust the transmission cycles of the ECU1 and the ECU2 to be different from one another.

In S105, the correction notification unit 56 may notify the ECU1 or ECU2 of a new offset value. For example, the correction notification unit 56 may notify the ECU1 and the ECU2 of new values of the transmission cycles, respectively.

### 2-3. Technical Effects

According to the second embodiment described above, in addition to the effect (1a) of the first embodiment described above, the following effect can be obtained.
(2a) In the second embodiment, when the determination unit 55 determines that there is a bias in the amount of communication data per unit time, the determination unit determines that the communication parameters need to be corrected. The correction notification unit 56 adjusts the communication parameters so as to suppress a bias in the amount of communication data per unit time.

When there is a bias in the amount of communication data per unit time, it is considered that traffic is temporarily concentrated on relay device 5 in a dense section. Therefore, there is a possibility that the buffer of relay device 5 may overflow. This can result in frames being delayed, and thus lower priority frames being discarded.

According to the above-described configuration of second embodiment, the traffic congestion can be eliminated, and the traffic in the communication system 100 can be leveled out as shown in FIG. 4B. The amount of communication data per unit time is always maintained within a range between the upper reference value H and the lower reference value L. Thus, it is possible to prevent the buffer of relay device 5 from being overflowed. Therefore, the communication quality of the communication network can be properly optimized.

According to the second embodiment, there is no need to adjust the capacity of buffer queue of the relay device 5 to the amount of communication data of the dense section. Therefore, the capacity of buffer queue in the relay device 5 may be configured to have a small size, and the network resources can be used efficiently.

When a high or low section exists in the traffic density, there is a possibility that an excessive load is being placed on the switching process that uses VLAN. In this case, the processing load on the CPU 41 of the relay device 5 becomes high. According to the above-described configuration of second embodiment, the unevenness of traffic amount can be eliminated, thereby preventing the processing load on the CPU 41 of the relay device 5 from becoming too high. This configuration allows the network resource to be used efficiently.

### 3. Third Embodiment

### 3-1. Difference From First Embodiment

The fundamental configuration of the second embodiment is similar to that of the first embodiment. Therefore, the difference therebetween will be mainly described below. The same reference symbol as in the first embodiment denote the same element, and reference is made to the preceding description.

In the third embodiment, the specific process for determining whether the communication parameters need to be corrected in S103 of FIG. 3 is different from the first embodiment. The specific process for adjusting the communication parameters so as to suppress the deterioration of the communication quality is different from that executed in S104 of FIG. 3 in the first embodiment. Further, the specific values of the communication parameters to be notified are different from the specific values notified in S105 of FIG. 3 in the first embodiment.

### 3-2. Process

In the third embodiment, the ECU 4 integrates and uses the sensor data transmitted from the ECU 1 to ECU 3. That is, the sensor data from each sensor is used in a fusing manner, and is also referred to as sensor-fused state. In such a case, the data from each sensor is sampled as close together as possible to one another. Therefore, the data from each sensor is transmitted from the ECU 1 to ECU 3 at a transmission time as close as possible to one another, and is received by the ECU 4 at a reception time as close as possible to one another.

In S103, the determination unit 55 of the correction device 6 determines whether the difference between the first transmission time, which is the earliest time among the multiple transmission times ST at which the ECU 1 to ECU 3 transmitted the respective frames, and the second transmission time, which is the latest time among the multiple transmission times ST at which the ECU 1 to ECU 3 transmitted the respective frames, exceeds a predetermined threshold value. The determination unit 55 determines whether the difference between the first reception time, which is the earliest time among the multiple reception times at which the ECU 4 received respective frames, and the second reception time, which is the latest time among the multiple reception times at which the ECU 4 received respective frames, exceeds a predetermined threshold value. When the determination unit 55 determines that the difference between the first transmission time and the second transmission time exceeds the threshold value and/or the difference between the first reception time and the second reception time exceeds the threshold value, the determination unit determines that correction of the communication parameters is necessary.

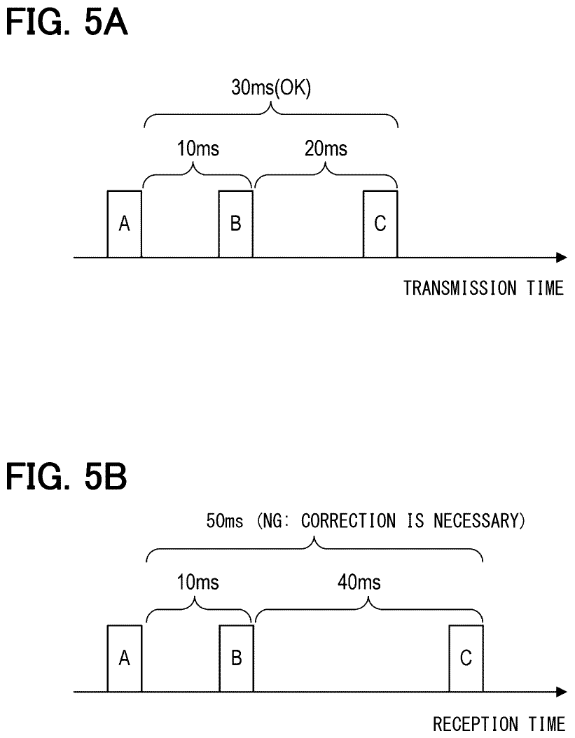

For example, a case will be described in which the ECU 1 transmits data A as a frame, the ECU 2 transmits data B as a frame, and the ECU 3 transmits data C as a frame. Data A corresponds to a frame transmitted at the first transmission time and a frame received at the first reception time. Data C corresponds to a frame transmitted at the second transmission time and received at the second reception time. The threshold is set to 30 ms (milliseconds). In FIG. 5A, the difference between the first transmission time and the second transmission time is 30 ms, which does not exceed the threshold. In FIG. 5B, the difference between the first reception time and the second reception times is 50 ms, which exceeds the threshold value. In this case, since the difference between the first reception time and the second reception time exceeds the threshold value, the determination unit 55 determines that the communication parameters need to be corrected.

In S104, the correction notification unit 56 adjusts the communication parameters so that the difference between the first transmission time and the second transmission time falls below the threshold value and the difference between the first reception time and the second reception time falls below the threshold value.

In the present embodiment, the correction notification unit 56 adjusts the transmission times so that, among three pieces of data A, B, and C, after the first piece of data is transmitted, the remaining two pieces of data are transmitted within the threshold value. The correction notification unit 56 adjusts the reception times so that, among three pieces of data A, B, and C, after the first piece of data is received, the remaining two pieces of data are received within the threshold value.

For example, suppose that a frame transmitted from one of multiple transmitting devices is received at the latest reception time and a priority of the frame received at the latest reception time is lower than the priorities of frames transmitted from other transmitting devices. In this case, for the multiple transmitting devices, the correction notification unit 56 may adjust the priority of the frame, which is received at the latest reception time from the transmitting device, to be higher than the current priority level for the transmitting device that has transmitted the frame with the latest reception time. Specifically, the correction notification unit 56 may adjust the priority of data C, which is received at the latest reception time, so as to make the priority of data C to be higher than the currently set priority. The configuration can shorten a period that the data C remains in the buffer of the relay device 5.

For example, the correction notification unit 56 may adjust the settings of output policing in the relay device 5. Specifically, the frame of data C may be adjusted to be transferred with higher priority.

When the difference between the first transmission time and the second transmission time exceeds the threshold value, there is a possibility that the transmission cycles and offsets of the multiple transmission devices are shifted from one another. In this case, the transmission cycles and offsets of multiple transmitting devices may be adjusted to match one another. Specifically, the correction notification unit 56 may adjust the transmission cycles of data A, B, and C to be same with one another, and adjust the offsets of the data A, B, and C to be same with one another.

In S105, the correction notification unit 56 may notify the ECU 3 of the new PCP value of the VLAN tag. For example, the correction notification unit 56 may notify the relay device 5 of new setting value for output policing. For example, the correction notification unit 56 may notify the ECU 1 to ECU 3 of new transmission cycles and offset values.

### 3-3. Technical Effects

According to the third embodiment described above, in addition to the effect (1a) of the first embodiment described above, the following effect can be obtained.
(3a) In the present embodiment, when the determination unit 55 determines that the difference between the first transmission time and the second transmission time exceeds the threshold value and/or the difference between the first reception time and the second reception time exceeds the threshold value, the determination unit determines that correction of the communication parameters is necessary. The correction notification unit 56 adjusts the communication parameters so that the difference between the first transmission time and the second transmission time falls below the threshold value and the difference between the first reception time and the second reception time falls below the threshold value. With this configuration, it is possible to suppress a variation in delay time of each frame. That is, the jitter of each frame can be improved. Therefore, in the communication system 100, the communication quality of the communication network can be properly optimized.

The receiving device can use data that are sampled at times close to one another. Therefore, the receiving device can use data suitable for a processing, which requires real-time performance or high response speed.

### 4. Other Embodiments

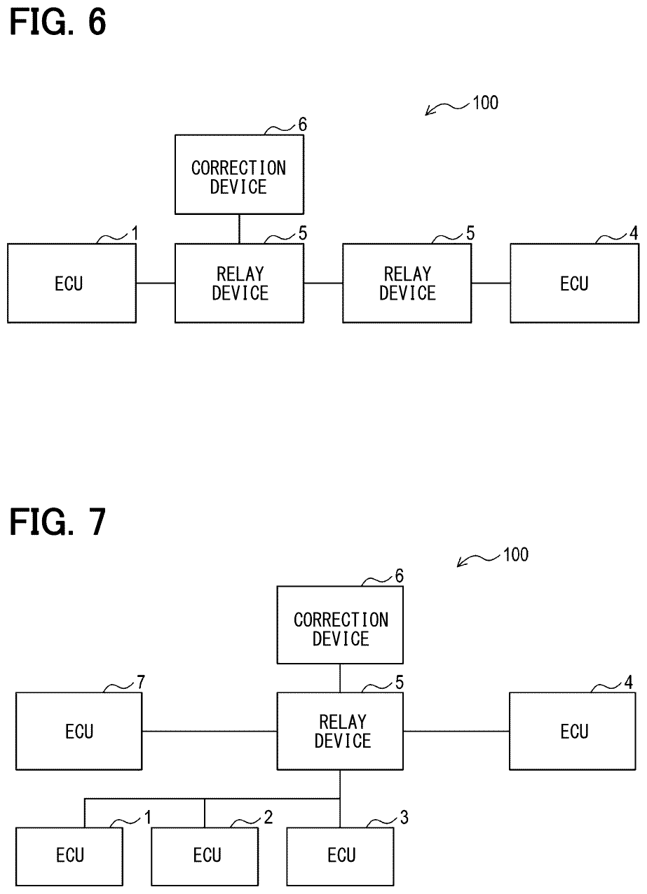

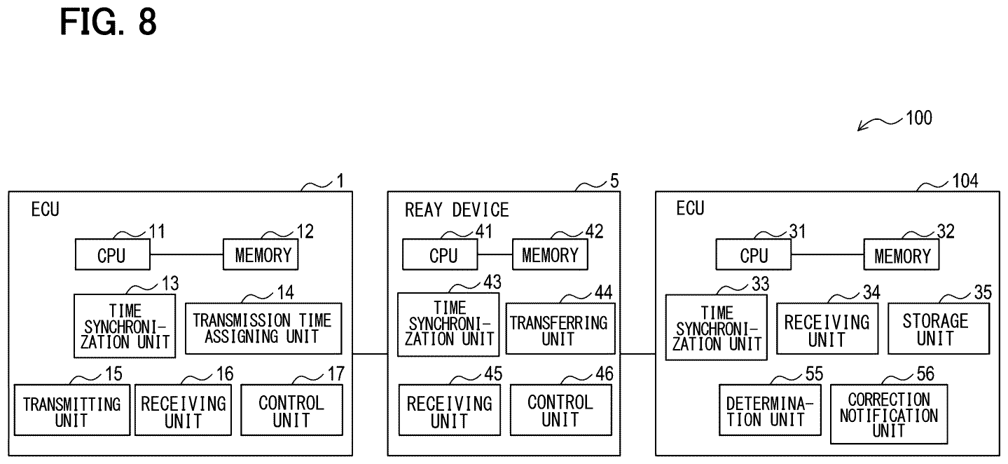

Although the embodiments of the present disclosure have been described above, it is needless to say that the present disclosure is not limited to the above-described embodiments, and can be modified in various forms.
(4a) In the above embodiments, the communication system 100 constitutes the in-vehicle network mounted on a vehicle. The type of network that the communication system 100 configures is not limited to the in-vehicle network. For example, the communication system 100 may configure a wide area network or an industrial network.
(4b) In the above embodiments, the communication system 100 includes one relay device 5. As shown in a first modification of FIG. 6, the communication system 100 may include multiple relay devices 5. In this configuration, the correction device 6 may notify the multiple relay devices 5 of new second communication parameters.
(4c) In the above embodiments, the ECU 1 to ECU 3 are connected in parallel with respect to the relay device 5. The manner in which the transmitting devices are connected to the relay device 5 is not limited to this example. For example, as shown in a second modification of FIG. 7, the transmitting devices may be connected to the relay device 5 in a multi-drop connection. The ECU 7 has the same configuration as the ECU 1 to ECU 3.
(4d) In the above embodiments, the ECU 4, which corresponds to the receiving device, and the relay device 5 are configured to be separate devices. As shown in a third modification of FIG. 8, an ECU 104 may be configured to have the functions of the receiving device and the correction device 6. Specifically, the ECU 104 serving as the receiving device may include the determination unit 55 and the correction notification unit 56. The ECU 104 may not include the notification unit 36, and the determination unit 55 may determine whether the first communication parameters and the second communication parameters need to be corrected based on the notification information stored in the storage unit 35.
(4e) In the correction notification process, the process executed in S103 to S105 of the first embodiment, the process executed in S103 to S105 of the second embodiment, and the process executed in S103 to S105 of the third embodiment may be executed in combined manner.
(4f) In the correction notification process, for example, the correction notification unit 56 may set a new time slot in S104, and notify a transmitting device of a new Ethernet TSN of the settings as the first communication parameters in S105. For example, the correction notification unit 56 may make an adjustment to set a new forwarding path in S104, and notify the relay device 5 of the new forwarding table as the second communication parameters in S105. For example, the correction notification unit 56 may adjust the conditions for frames to be passed through the relay device 5 in S104, and notify the relay device 5 of the new access control list as the second communication parameters in S105.
(4g) Each of the devices and the method described in the present disclosure (that is, ECU 1 to ECU 4, relay device 5, and correction device 6) and the technology used by each of the devices may be implemented by a special-purpose computer provided by configuring a processor and memory programmed to perform one or more functions embodied in a computer program. Alternatively, each of the devices and the method used by each of devices described in the present disclosure may be implemented by a special purpose computer provided by configuring a processor with one or more special purpose hardware logic circuits. Alternatively, each of the devices and the method used by each of devices described in the present disclosure may be implemented by one or more special-purpose computer configured by a combination of a processor and memory programmed to perform one or more functions and a processor configured by one or more hardware logic circuits. The computer program may be stored in a computer-readable non-transitory tangible storage medium as instructions to be executed by the computer. A method for implementing the functions of each functional unit included in each device does not necessarily include software, and all of the functions may be implemented by using one or multiple hardware circuits.

In the present disclosure or the claims, the term “processor” may refer to a single hardware processor or several hardware processors that are configured to execute processing defined by computer program code (i.e., one or more instructions of a computer program) by sequentially reading the computer program code included in a computer program. In other words, a “processor” is a hardware device that executes one or more program processes. Therefore, the computer program code can be considered software that defines the processing of the processor according to its content. The “processor” may be a general-purpose or specific-purpose processor, such as, CPU (Central Processing Unit), a microprocessor, GPU (Graphics Processing Unit) and DFP (Data Flow Processor), but is not limited to these examples.

In the present disclosure or the claims, the term “memory” is a non-transitory tangible storage medium and may refer to a single or several hardware memories configured to store computer program code and/or data in a manner accessible by the processor. The “memory” may be implemented using any suitable memory technology, such as SRAM (Static Random-access Memory), SDRAM (Synchronous Dynamic RAM), nonvolatile/flash memory, or other types of memory. The computer program code that constitutes the program is stored on the memory and, when executed by a processor, causes the processor to realize the various functions described above.

In the present disclosure or the claims, the term “circuit” refers to a single hardware logic circuit or several hardware logic circuits (in other words, “circuitry”) that are configured to execute specific processing defined based on a pre-designed circuit configuration. In other words (and in contrast to the “processor”), the term “circuit” in the present disclosure or the claims refers to a hardware device that executes specific processing based on a circuit configuration, not processing defined by software such as the above-described computer program code. For instance, “circuit” may include a custom IC (Integrated Circuit) such as ASIC (Application Specific Integrated Circuit) or FPGA (Field Programmable Gate Array) designed using a hardware description language (HDL). That is, the term “circuit” in the present disclosure or the claims includes all hardware circuits except the above-described processor that executes processing by reading computer program code.

In the present disclosure or the claims, the phrase “at least one of a circuit and a processor” should be interpreted disjunctively (logical OR) and should not be interpreted as at least one circuit and at least one processor. Therefore, in the present disclosure or the claim, “at least one of a circuit and a processor is configured to cause the correction device to execute functions” includes the case where only the circuit causes the correction to execute all the functions. Additionally, “at least one of a circuit and a processor is configured to cause the correction device to execute functions” includes the case where only the processor causes the correction device to execute all the functions. Furthermore, “at least one of a circuit and a processor is configured to cause the correction device to execute functions” includes the case where the circuit causes the correction device to execute some of the functions and the processor causes the correction device to execute the remaining functions. In the last case, for instance, if the correction device executes functions A to C, functions A and B may be implemented by the circuit, and the remaining function C may be implemented by the processor.
(4h) The multiple functions of one component in the above embodiments may be implemented by multiple components, or a function of one component may be implemented by multiple components. Multiple functions of multiple elements may be implemented by one element, one function provided by multiple elements may be implemented by one element. In the above embodiment, a part of the configuration may be properly omitted. At least a part of the configuration of the above embodiment may be added to or substituted for the configuration of the other embodiment.
(4i) In addition to the communication system 100 described above, the present disclosure can also be implemented in various forms, such as each device included in the communication system 100, a program for causing a computer to function as each device included in the communication system 100, a non-transitory tangible storage medium such as a semiconductor memory in which the above-described program is stored, and a correction method thereof.

What is claimed is:

1. A correction device used in a communication system, the communication system including multiple communication devices and at least one relay device via which the multiple communication devices are communicatively connected, the multiple communication devices including a first communication device and a second communication device, the correction device being one of the multiple communication devices, and the correction device comprising:
at least one of (i) a circuit and (ii) a processor with a memory storing computer program code executable by the processor, the at least one of the circuit and the processor configured to cause the correction device to implement:
a determination unit configured to determine whether a communication parameter, which is set in a transmission setting for transmitting a frame in at least one target device, needs to be corrected based on time information, which is included in the frame when the frame is transmitted from the first communication device to the second communication device via the at least one relay device, the at least one target device being defined as the first communication device and/or the at least one relay device, and the at least one target device performing a communication according to the communication parameter, which is related to a communication quality; and
a correction notification unit configured to adjust the communication parameter to suppress a deterioration in the communication quality when the determination unit determines that the communication parameter needs to be corrected, the correction notification unit further configured to notify the at least one target device of a new communication parameter that has been adjusted,
wherein the at least one target device corrects the communication parameter in response to the new communication parameter being notified by the correction notification unit of the correction device.

2. The correction device according to claim 1, wherein
the determination unit determines whether a difference between a transmission time, which is a time when the first communication device transmits the frame, and a reception time, which is a time when the second communication device receives the frame, is equal to or greater than a predetermined tolerance value,
when the determination unit determines that the difference between the transmission time and the reception time is equal to or greater than the tolerance value, the determination unit determines that the communication parameter needs to be corrected, and
the correction notification unit notifies the at least one target device of the new communication parameter, which is adjusted such that the difference between the transmission time and the reception time is decreased below the tolerance value.

3. The correction device according to claim 1, wherein
the multiple communication devices include multiple first communication devices,
the determination unit determines whether there is a bias in an amount of communication data per unit time,
the amount of communication data per unit time is calculated based on (i) each transmission time, which is a time when each of the multiple first communication devices transmits the frame and (ii) a size of the frame transmitted from each of the multiple first communication devices,
in response to determining that there is a bias in the amount of communication data per unit time, the determination unit determines that the communication parameter needs to be corrected, and
the correction notification unit notifies the at least one target device of the communication parameter, which is adjusted to suppress the bias in the amount of communication data per unit time.

4. The correction device according to claim 1, wherein
the multiple communication devices include multiple first communication devices,
the determination unit determines whether a difference between (i) a first transmission time, which is an earliest time among transmission times at which the multiple first communication devices respectively transmit frames, and (ii) a second transmission time, which is a latest time among the transmission times at which the multiple first communication devices respectively transmit the frames, exceeds a predetermined threshold value,
the determination unit determines whether a difference between (i) a first reception time, which is an earliest time among reception times at which the second communication device receives the frames from the multiple first communication devices, and (ii) a second reception time, which is a latest time among the reception times at which the second communication device receives the frames from the multiple first communication devices, exceeds the predetermined threshold value,
the determination unit determines that the communication parameter needs to be corrected in response to determining that the difference between the first transmission time and the second transmission time exceeds the predetermined threshold value and/or the difference between the first reception time and the second reception time exceeds the predetermined threshold value, and
the correction notification unit notifies the at least one target device of the communication parameter, which is adjusted so that the difference between the first transmission time and the second transmission time decreases below the predetermined threshold value and the difference between the first reception time and the second reception time decreases below the predetermined threshold value.

5. A communication system comprising:
a plurality of communication devices; and
at least one relay device via which the plurality of communication devices are connected, wherein
the plurality of communication devices include:
a first communication device;
a second communication device; and
a correction device,
the first communication device and/or the at least one relay device is defined as at least one target device,
the correction device includes at least one of (i) a circuit and (ii) a processor with a memory storing computer program code executable by the processor, the at least one of the circuit and the processor are configured to cause the correction device to implement:
a determination unit configured to determine whether a communication parameter, which is set in a transmission setting for transmitting a frame in the at least one target device, needs to be corrected based on time information, which is included in the frame when the frame is transmitted from the first communication device to the second communication device via the at least one relay device, and the at least one target device performing a communication according to the communication parameter, which is related to a communication quality; and
a correction notification unit configured to adjust the communication parameter to suppress a deterioration in a communication quality when the determination unit determines that the communication parameter needs to be corrected, the correction notification unit further configured to notify the at least one target device of a new communication parameter that has been adjusted, and
the at least one target device corrects the communication parameter in response to the new communication parameter being notified by the correction notification unit of the correction device.

6. A computer-implemented correction method to be carried out by at least one of (i) a circuit and (ii) a processor of a correction device, the correction device being used in a communication system, the communication system including multiple communication devices and at least one relay device via which the multiple communication devices being communicatively connected, the multiple communication devices including a first communication device and a second communication device, the correction device being one of the multiple communication devices,
the correction method comprising:
determining whether a communication parameter, which is set in a transmission setting for transmitting a frame in at least one target device, needs to be corrected based on time information, which is included in the frame when the frame is transmitted from the first communication device to the second communication device via the at least one relay device, the at least one target device being defined as the first communication device and/or the at least one relay device, and the at least one target device performing a communication according to the communication parameter, which is related to a communication quality;
adjusting the communication parameter to suppress a deterioration in the communication quality in response to determining that the communication parameter needs to be corrected; and
notifying the at least one target device of a new communication parameter that has been adjusted,
wherein the at least one target device corrects the communication parameter in response to the new communication parameter being notified by the correction device.
